(19) United States
(12) Patent Application Publication
(10) Pub. No.: US 2026/0194171 A1
(43) Pub. Date: Jul. 9, 2026

(54) TUBE ATTACHMENT/DETACHMENT MEMBER FOR PIPE JOINT, PIPE JOINT, AND PIPE JOINT ASSEMBLY METHOD

(71) Applicant: NITTA CORPORATION, Osaka-shi, Osaka (JP)

(72) Inventors: Masafumi MATSUMOTO, Nabari-shi, Mie (JP); Ayame TANAKA, Nabari-shi, Mie (JP); Kenji ASAKURA, Nabari-shi, Mie (JP)

(21) Appl. No.: 19/134,376

(22) PCT Filed: Jan. 15, 2024
(86) PCT No.: PCT/JP2024/000770

§ 371 Date: May 30, 2025

(30) Foreign Application Priority Data
Feb. 22, 2023 (JP) 2023-026591

(51) Int. Cl. F16L 37/091

(52) U.S. Cl. CPC F16L 37/0915

(57) ABSTRACT

A tube attachment/detachment member for connecting a tube and a body includes a lock ring that is formed such that the tube is insertable and holds the inserted tube; a release ring that releases the holding of the tube by the lock ring; a cap accommodating the lock ring and the release ring; and a back ring that restricts movement of the lock ring and the release ring. The back ring is provided in the cap, and the cap is formed such that an outer periphery of the body is capable of being fitted therein.

### TECHNICAL FIELD

The present invention relates to a tube attachment/detachment member for a pipe joint, a pipe joint, and a pipe joint assembly method.

### BACKGROUND ART

A pipe joint is used for piping of a flowing substances such as compressed air, gas, and liquid. Patent Literature 1 discloses a pipe joint in which a lock ring prevents a tube from coming off.

The pipe joint disclosed in Patent Literature 1 includes a release ring having a distal end portion in contact with or close to the lock ring, and a tubular cap externally fitted to the release ring. The lock ring includes a claw that prevents the tube from coming off. When the tube is inserted into the lock ring, the claw of the lock ring bites into a surface of the tube, and the tube is held by the lock ring. The release ring is provided in the cap in a manner of being movable forward and backward with respect to the lock ring. When the release ring is pushed in an insertion direction of the tube, the claw of the lock ring is pressed backward and released from the tube. Accordingly, the tube can be removed. The cap is press-fitted into a connection hole of a housing of a valve to fix the lock ring in the connection hole and prevent the release ring from coming off. Here, the housing corresponds to a body of the pipe joint.

### CITATION LIST

### Patent Literature

Patent Literature 1: JP2016-089884A

### SUMMARY OF INVENTION

### Technical Problem

In the pipe joint disclosed in Patent Literature 1, a seal member, a back ring including the lock ring, and the release ring are sequentially incorporated into the connection hole of the housing corresponding to the body of the pipe joint, and then the cap is press-fitted into the connection hole. In such a configuration, when there are several tube attachment/detachment portions of the pipe joint, a pipe joint assembling operation is complicated, and it is difficult to automate the assembling operation.

An object of the present invention is to simplify an assembling operation of a pipe joint including a tube attachment/detachment member.

### Solution to Problem

The present invention relates to a tube attachment/detachment member for connecting a tube and a body, the tube attachment/detachment member includes: a lock ring that is formed such that the tube is insertable and holds the inserted tube; a release ring that releases the holding of the tube by lock ring; a cap accommodating the lock ring and the release ring; and a back ring that restricts movement of the lock ring and the release ring, the back ring is provided in the cap, and the cap is formed such that an outer periphery of the body is capable of being fitted therein.

The present invention relates to a pipe joint attaching method for attaching a tube attachment/detachment member for connecting the tube and a body to the body, the tube attachment/detachment member includes a lock ring that is formed such that the tube is insertable and holds the inserted tube, a release ring that releases the holding of the rube by the lock ring, a cap accommodating the lock ring and the release ring, and a back ring that is provided in the cap and restricts movement of the lock ring and the release ring, and the pipe joint attaching method includes: fitting an outer periphery of the body into the cap of the tube attachment/detachment member assembled in advance.

### Advantageous Effects of Invention

According to the present invention, a release ring and a lock ring are attached to a cap, and the release ring and the lock ring are prevented from being detached from the cap by a back ring, thereby constituting a tube attachment/detachment member. The cap is formed such that an outer periphery of a body can be fitted, and a pipe joint is formed by fitting the cap of the tube attachment/detachment member into the body to which a seal member is attached. Since the tube attachment/detachment member is common regardless of a shape of the pipe joint, it is easy to automatically assemble only the tube attachment/detachment member.

### BRIEF DESCRIPTION OF DRAWINGS

FIG. 1 is a half vertical cross-sectional view of a tube attachment/detachment member according to an embodiment, showing a state in which a tube and a body are connected.

FIG. 2 is an enlarged detail view of a portion A in FIG. 1.

FIG. 3 is a plan view of a lock ring.

FIG. 4 is an enlarged detail view showing a state before the tube is inserted into the lock ring and corresponds to FIG. 2.

FIG. 5 is an enlarged detail view showing a state in which the holding of the tube by the lock ring is released and corresponds to FIG. 2.

FIG. 6 is a half vertical cross-sectional view of the tube attachment/detachment member before being attached to the body.

### DESCRIPTION OF EMBODIMENTS

Hereinafter, an embodiment of the present invention will be described in detail with reference to the drawings. The embodiment described below is an example of the present invention, and the present invention is not limited thereto. In the following description of the embodiment, the same components are denoted by the same reference numerals, and the description thereof will be appropriately omitted.

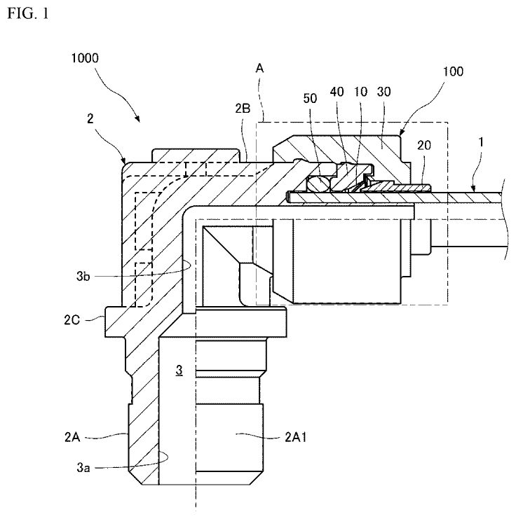

FIG. 1 shows a half vertical cross-sectional view of a tube attachment/detachment member 100 according to an embodiment of the present invention. FIG. 1 shows a state in which a tube 1 and a body 2 are connected by the tube attachment/detachment member 100 to form a pipe connection structure. The tube attachment/detachment member 100, the body 2, and a sealing member 50 to be described later form a pipe joint 1000. The body 2 is an L-shaped joint that is connected to an adapter or a device (not shown), but these are merely examples of the body 2 and are not limited thereto.

A material constituting the tube 1 may be a polyurethane resin, a nylon resin, a polyethylene resin, or the like. A material constituting the body 2 may be polyamide 12 (PA12) reinforced with glass fiber (GF), polyamide 11 (PA11) reinforced with GF, PPA reinforced with GF, copper alloys (C3771 and the like), lead-free copper alloys, aluminum alloys, stainless steel alloys, and the like.

The tube 1 and the body 2 connected to each other using the tube attachment/detachment member 100 can be used, for example, in air brake piping of automobiles including commercial vehicles (trucks, buses, and the like). The pipe connection structure may be used in construction machines, machine tools, and the like. Further, a flowing substance through the tube 1 and the body 2 is not limited to air, but may be other gases or liquids.

As shown in FIG. 1, the body 2 is a cylindrical member bent into an L shape. Specifically, the body 2 includes a vertical portion 2A extending vertically and a horizontal portion 2B bent at a substantially right angle from an upper end of the vertical portion 2A and extending horizontally as one unit. Inside the body 2, a flow path 3 bent into an L shape is formed by circular holes 3a and 3b having different diameters. In the present embodiment, although the body 2 is a member bent into the L shape, the body 2 may be a member having various shapes not limited to the L shape, such as an F shape, a T shape, or a Y shape, or may be a union shape.

A flange portion 2C is integrally formed at an intermediate height position of an outer periphery of the vertical portion 2A of the body 2. A portion below the flange portion 2C constitutes an insertion portion 2A1 to be inserted into an adapter (not shown).

The tube attachment/detachment member 100 is attached to an opening-side end portion of the horizontal portion 2B of the body 2. The tube attachment/detachment member 100 holds the tube 1. In other words, the tube 1 and the body 2 are connected by the tube attachment/detachment member 100.

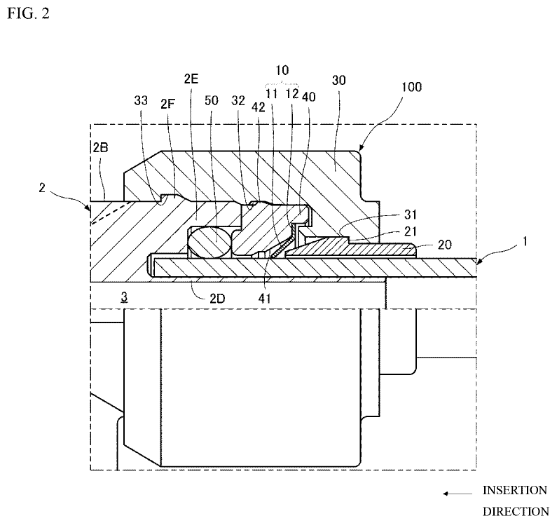

FIG. 2 is an enlarged detail view of a portion A in FIG. 1. As shown in FIG. 2, the horizontal portion 2B of the body 2 includes an inner cylindrical portion 2D and an outer cylindrical portion 2E provided in a manner of surrounding the inner cylindrical portion 2D. The inner cylindrical portion 2D extends from the outer cylindrical portion 2E. The opening-side end portion of the horizontal portion 2B is formed by the inner cylindrical portion 2D and the outer cylindrical portion 2E. The inner cylindrical portion 2D is inserted into the tube 1.

The tube attachment/detachment member 100 includes a lock ring 10 that holds the tube 1, a release ring 20 provided side by side with the lock ring 10, and a cap 30 that accommodates the lock ring 10 and the release ring 20. The lock ring 10 is made of metal, for example. The release ring 20 and the cap 30 are made of a resin, for example.

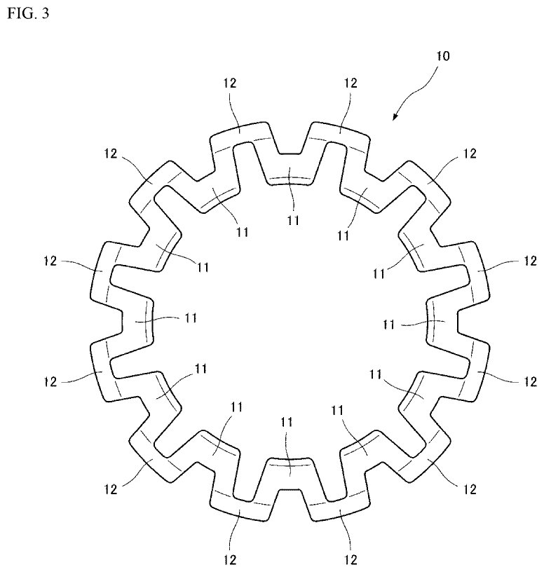

FIG. 3 is a plan view of the lock ring 10. As shown in FIG. 3, the lock ring 10 includes a plurality of claws 11 arranged in an annular shape and connection portions 12 that connect adjacent claws 11 in a circumferential direction.

The “circumferential direction” means a direction around a central axis of the lock ring 10. Hereinafter, a radial direction about the central axis of the lock ring 10 is referred to as a “radial direction”.

Each of the connection portions 12 is disposed radially outward of the claw 11. That is, the lock ring 10 is a zigzag-shaped annular member in which the claw 11 is disposed relatively radially inward and the connection portion 12 is disposed radially outward.

As shown in FIG. 2, the tube 1 is inserted into the lock ring 10. An insertion direction of the tube 1 is a direction from right to left in FIG. 2. Hereinafter, the insertion direction of the tube 1 is also simply referred to as an “insertion direction”. The claw 11 of the lock ring 10 is inclined with respect to the insertion direction so as to approach the insertion direction as the claw 11 extends radially inward.

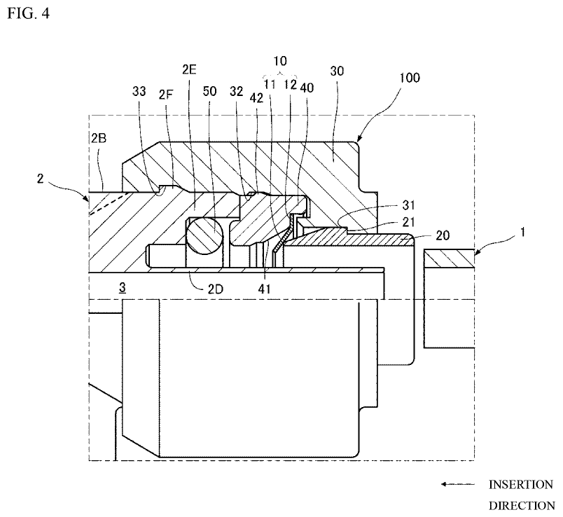

FIG. 4 is an enlarged detail view showing a state before the tube 1 is inserted into the lock ring 10 and corresponds to FIG. 2. As shown in FIG. 4, in a state in which the tube 1 is not inserted into the lock ring 10, an interval between the claws 11 facing each other in the radial direction is smaller than an outer diameter of the tube 1. When the tube 1 is inserted into the lock ring 10, the claws 11 of the lock ring 10 are pressed by the tube 1 in the insertion direction and deformed such that the interval between the claws 11 facing each other in the radial direction increases (see FIG. 2).

As shown in FIG. 2, in a state in which the tube 1 is inserted into the lock ring 10, a restoring force is generated in the lock ring 10, and the claws 11 abut against the tube 1 in a radially inward direction. Therefore, in the state shown in FIG. 2, when the tube 1 is pulled out from the lock ring 10 in a direction opposite to the insertion direction, the claws 11 of the lock ring 10 bite into the tube 1. Therefore, the tube 1 can be prevented from being pulled out from the lock ring 10.

In this way, the lock ring 10 abuts against the tube 1 in the radially inward direction to hold the tube 1.

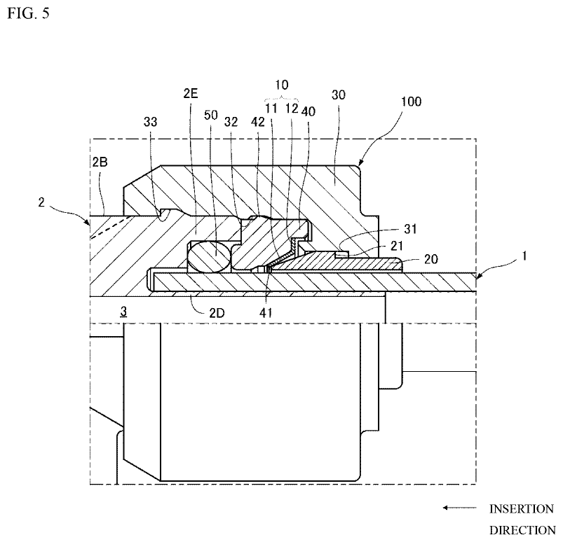

The release ring 20 releases the holding of the tube by the lock ring 10. FIG. 5 is an enlarged detail view showing a state in which the holding of the tube by the lock ring 10 is released and corresponds to FIG. 2.

As shown in FIGS. 2 and 5, the release ring 20 is aligned with the lock ring 10 in the insertion direction. A central axis of the release ring 20 substantially coincides with the central axis of the lock ring 10, and the tube 1 is inserted into the release ring 20.

The release ring 20 extends from the cap 30 in a direction opposite to the insertion direction, and a user can operate the release ring 20. When the user presses the release ring 20 in the insertion direction, the release ring 20 moves in the insertion direction. Hereinafter, the movement in the insertion direction is also referred to as “forward movement”, and movement in the direction opposite to the insertion direction is also referred to as “backward movement”. That is, the release ring 20 is accommodated in the cap 30 in a manner of being movable forward and backward relative to the lock ring 10.

When the release ring 20 is moved forward by an operation of the user, the release ring 20 pushes the claws 11 of the lock ring 10 in the insertion direction as shown in FIG. 5. Accordingly, the interval between the claws 11 facing each other in the radial direction increases, and the claws 11 move away from the tube 1. In this state, even if the tube 1 is pulled in the direction opposite to the insertion direction, the claws 11 of the lock ring 10 do not bite into the tube 1. Therefore, the tube 1 can be pulled out from the lock ring 10.

In this way, the release ring 20 releases the holding of the tube 1 by the lock ring 10 by deforming the lock ring 10 to separate the lock ring 10 from the tube 1.

The cap 30 includes a backward movement restriction portion 31 that restricts the backward movement of the release ring 20. Specifically, the backward movement restriction portion 31 is a step portion protruding radially inward. The release ring 20 includes a step portion 21 protruding radially outward, and the backward movement restriction portion 31 faces the step portion 21 in the insertion direction. The release ring 20 does not move backward in a state in which the backward movement restriction portion 31 and the step portion 21 are in contact. Therefore, the release ring 20 can be prevented from coming off from the cap 30 in the direction opposite to the insertion direction.

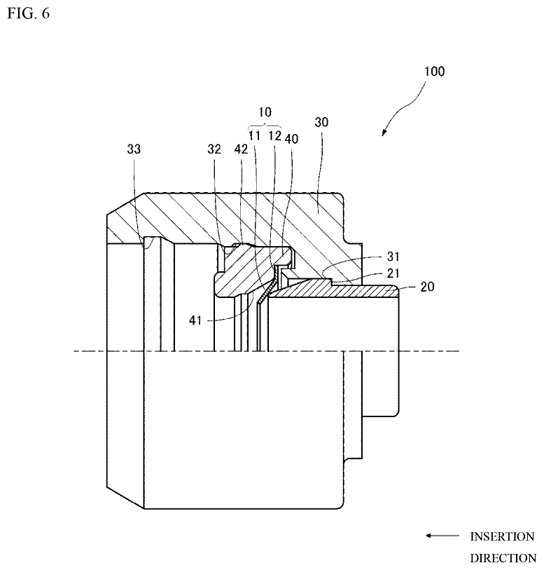

FIG. 6 is a half vertical cross-sectional view of the tube attachment/detachment member 100 before being attached to the body 2. As shown in FIG. 6, the tube attachment/detachment member 100 includes a back ring 40 that restricts the movement of the lock ring 10 and the release ring 20 in the insertion direction. The back ring 40 is made of, for example, resin.

The lock ring 10 is attached inside the back ring 40. The back ring 40 is formed with a step portion that comes into contact with the connection portions 12 of the lock ring 10, and the step portion restricts displacement of the connection portions 12 of the lock ring 10 in the insertion direction.

The back ring 40 includes an inclined surface 41 inclined with respect to the insertion direction. Similar to the claws 11 of the lock ring 10, the inclined surface 41 is inclined with respect to the insertion direction so as to approach the insertion direction as the inclined surface 41 extends radially inward. As shown in FIG. 5, in a state in which the release ring 20 deforms the lock ring 10 to separate the lock ring 10 from the tube 1, the inclined surface 41 comes into contact with the claws 11 of the lock ring 10 to restrict the deformation of the lock ring 10 caused by the release ring 20. Therefore, excessive deformation of the lock ring 10 can be prevented. Thus, it is possible to prevent the lock ring 10 from being damaged and becoming unable to hold the tube 1. In addition, the back ring 40 is sized to function as a backup ring for the sealing member 50, and further has a stepped shape for fixing the sealing member 50.

The back ring 40 is provided in the cap 30. A central axis of the back ring 40 and the central axis of the lock ring 10 substantially coincide with each other, and in a state in which the tube 1 is inserted into the lock ring 10 (see FIG. 2), the tube 1 is inserted into the back ring 40.

The back ring 40 is fitted into the cap 30. Specifically, a protrusion 42 protruding radially outward is formed on an outer periphery of the back ring 40, and a first recessed portion 32 in which the protrusion 42 can be disposed is formed on an inner periphery of the cap 30. The protrusion 42 and the first recessed portion 32 are formed in an annular shape along a circumferential direction, for example. When the back ring 40 is inserted into the cap 30, the protrusion 42 is disposed in the first recessed portion 32, and the back ring 40 is retained in the cap 30.

Fitting of the back ring 40 into the cap 30 is not limited to a form of the protrusion 42 and the first recessed portion 32. For example, a recessed portion may be formed in the outer periphery of the back ring 40, a protrusion may be formed on the inner periphery of the cap 30, and the protrusion may be disposed in the recessed portion to retain the back ring 40 in the cap 30. A male screw may be formed on the outer periphery of the back ring 40 and a female screw may be formed on the inner periphery of the cap 30, and the back ring 40 may be retained in the cap 30 by screwing the male screw and the female screw. An outer shape of the back ring 40 may be made larger than an inner shape of the cap 30 in a state in which the back ring 40 is not inserted into the cap 30, and as the back ring 40 is inserted into the cap 30, the back ring 40 may expand the cap 30, thereby holding the back ring 40 on the cap 30. Further, a material for the back ring 40 may be metal, and the protrusion 42 may have an edge shape and be press-fitted into the cap 30 in which the first recessed portion 32 is not formed.

A second recessed portion 33 different from the first recessed portion 32 is formed on the inner periphery of the cap 30. The second recessed portion 33 is located on an insertion direction side (left side in FIG. 6) with respect to the back ring 40.

As shown in FIG. 2, the outer cylindrical portion 2E of the body 2 is inserted into the cap 30. In a state in which the outer cylindrical portion 2E is inserted into the cap 30, a protrusion 2F formed on an outer periphery of the outer cylindrical portion 2E is disposed in the second recessed portion 33 of the cap 30, and the cap 30 is retained by the body 2. That is, the cap 30 is formed such that the outer periphery of the body 2 can be fitted therein.

The fitting of the body 2 into the cap 30 is not limited to a form of the protrusion 2F and the second recessed portion 33. A protrusion may be formed on the inner periphery of the cap 30 and a recessed portion may be formed in the outer periphery of the body 2, the protrusion may be disposed in the recessed portion, and the cap 30 may be retained by the body 2. A female screw may be formed on the inner periphery of the cap 30 and a male screw may be formed on the outer periphery of the body 2, and the cap 30 may be retained by the body 2 by screwing the female screw and the male screw. Further, the inner shape of the cap 30 may be made smaller than an outer shape of the body 2 in a state in which the body 2 is not inserted into the cap 30, and as the body 2 is inserted into the cap 30, the cap 30 may be expanded by the body 2, thereby holding the cap 30 on the body 2.

In this way, in the tube attachment/detachment member 100, the back ring 40 provided in the cap 30 limits the movement of the lock ring 10 and the release ring 20 which are accommodated in the cap 30, and the cap 30 is formed such that the outer periphery of the body 2 can be fitted therein.

Although members of various shapes (L shape, F shape, T shape, Y shape, and the like) and sizes are used for the body 2, the same member can be used for the tube attachment/detachment member 100 as long as the body has the same outer diameter dimension as the corresponding tube. Therefore, the tube attachment/detachment member 100 can be assembled and stored in advance, and then assembled in a separate process according to the shape of the body 2, and completed as the pipe joint 1000. Further, an assembly of the tube attachment/detachment member 100 can be easily automated by a machine.

When the tube 1 and the body 2 are connected by the tube attachment/detachment member 100, the sealing member 50 is provided between an outer periphery of the tube 1 and an inner periphery of the outer cylindrical portion 2E of the body 2. The sealing member 50 is made of an elastic material such as rubber. The sealing member 50 is in contact with the outer periphery of the tube 1 and the inner periphery of the outer cylindrical portion 2E of the body 2 to block a gap between the tube 1 and the body 2 and ensure airtightness. Therefore, it is possible to prevent the flowing substance from leaking from the gap between the tube 1 and the body 2.

The sealing member 50 is accommodated in a step portion formed on the outer cylindrical portion 2E of the body 2. The back ring 40 is adjacent to the outer cylindrical portion 2E in the insertion direction and prevents the sealing member 50 from coming out of the outer cylindrical portion 2E.

Next, a method for attaching the tube attachment/detachment member 100 to the body 2 will be described. In attaching the tube attachment/detachment member 100, the tube attachment/detachment member 100 is pre-assembled.

In one example of assembling the tube attachment/detachment member 100, the release ring 20 is attached to the cap 30 in the direction opposite to the insertion direction. The lock ring 10 is attached to the back ring 40. The back ring 40 is press-fitted into the cap 30. When the protrusion 42 of the back ring 40 is disposed in the first recessed portion 32 of the cap 30, the back ring 40 is retained in the cap 30, and the assembly of the tube attachment/detachment member 100 is completed.

When the tube attachment/detachment member 100 is assembled, the backward movement restriction portion 31 of the cap 30 prevents the lock ring 10 and the release ring 20 from coming off in the direction opposite to the insertion direction, and the back ring 40 prevents the lock ring 10 and the release ring 20 from coming off in the insertion direction.

In order to attach the tube attachment/detachment member 100 to the body 2, first, the sealing member 50 is placed inside the outer cylindrical portion 2E of the body 2. Thereafter, an outer periphery of the cap 30 is held, and the outer cylindrical portion 2E of the body 2 is inserted into the cap 30 (FIG. 4). When the protrusion 2F of the body 2 is disposed in the second recessed portion 33 of the cap 30, the cap 30 is retained by the body 2. Thus, the attachment of the tube attachment/detachment members 100 is completed.

In order to connect the tube 1 to the body 2, as shown in FIG. 2, the tube 1 may be inserted into the tube attachment/detachment member 100. When the tube 1 is inserted, the tube 1 is held by the lock ring 10. The interval between the claws 11 of the lock ring 10 may be increased by pushing the release ring 20 in the insertion direction when the tube 1 is inserted.

In order to remove the tube 1 from the body 2, first, the release ring 20 is pushed in the insertion direction to widen the interval between the claws 11 of the lock ring 10. Accordingly, the holding of the tube 1 by the lock ring 10 is released. In this state, the tube 1 is pulled in the direction opposite to the insertion direction. Accordingly, the tube 1 is detached from the body 2.

Although the embodiment of the present invention has been described above, the present invention is not limited to the above-described embodiment, and can be appropriately changed within the scope of the gist of the present invention.

In the above embodiment, the body 2 includes the inner cylindrical portion 2D, but may not include the inner cylindrical portion 2D.

In the above embodiment, the back ring 40 restricts the movement of the lock ring 10 and the release ring 20 and restricts the deformation of the lock ring 10 caused by the release ring 20. The back ring 40 may simply restrict the movement of the lock ring 10 and the release ring 20. In this case, a member that restricts the deformation of the lock ring 10 caused by the release ring 20 is preferably provided separately from the back ring 40.

### REFERENCE SIGN LIST

100 tube attachment/detachment member
1000 pipe joint
1 tube
2 body
10 lock ring
20 release ring
30 cap
40 back ring
50 sealing member

1. A tube attachment/detachment member for connecting a tube and a body, the tube attachment/detachment member comprising:
a lock ring that is formed such that the tube is insertable and holds the inserted tube;
a release ring that releases the holding of the tube by the lock ring;
a cap accommodating the lock ring and the release ring; and
a back ring that restricts movement of the lock ring and the release ring, wherein
the back ring is provided in the cap, and
the cap is formed such that an outer periphery of the body is capable of being fitted therein.

2. The tube attachment/detachment member according to claim 1, wherein
the lock ring abuts against the tube and holds the tube,
the release ring deforms the lock ring to separate the lock ring from the tube, and releases the holding of the tube by the lock ring, and
the back ring restricts the deformation of the lock ring caused by the release ring.

3. The tube attachment/detachment member according to claim 1, wherein
the back ring is fitted into the cap.

4. A pipe joint comprising:
the tube attachment/detachment member according to claim 1;
the body fitted into the cap; and
a sealing member that is provided on the body and blocks a gap between the tube and the body.

5. A pipe joint assembly method for attaching a tube attachment/detachment member for connecting the tube and a body to the body,
the tube attachment/detachment member comprising a lock ring that is formed such that the tube is insertable and holds the inserted tube, a release ring that releases the holding of the tube by the lock ring, a cap accommodating the lock ring and the release ring, and a back ring that is provided in the cap and restricts movement of the lock ring and the release ring,
the pipe joint assembly method comprising:
fitting an outer periphery of the body into the cap of the tube attachment/detachment member assembled in advance.
